(19) United States
(12) Patent Application Publication
(10) Pub. No.: US 2025/0059344 A1
(43) Pub. Date: Feb. 20, 2025

(54) A METHOD TO DEINK AND/OR TO DELAMINATE PLASTIC MATERIAL USING AN AMINE

(71) Applicant: UNIVERSITEIT GENT, Gent (BE)

(72) Inventors: Steven DE MEESTER, Brakel (BE); Sibel ÜGDÜLER, Merelbeke (BE); Martijn ROOSEN, Oostakker (BE)

(73) Assignee: UNIVERSITEIT GENT, Gent (BE)

(21) Appl. No.: 18/719,927

(22) PCT Filed: Dec. 16, 2022
(86) PCT No.: PCT/EP2022/086268

§ 371 Date: Jun. 14, 2024

(30) Foreign Application Priority Data
Dec. 17, 2021 (EP) 21215605.3

(51) Int. Cl. C08J 11/28

(52) U.S. Cl. CPC C08J 11/28

(57) ABSTRACT

The invention relates to a method to deink and/or to delaminate plastic material, preferably to a method to deink and delaminate plastic material in a single step. The method comprises the step of contacting the plastic material with an amine or a composition comprising said amine, wherein the amine comprises a nitrogen atom having at least one hydrocarbon substituent comprising an acyclic or cyclic alkyl group. The total number of carbon atoms of all hydrocarbon substituents of the nitrogen atom is at least (5).

### FIELD OF THE INVENTION

The present invention relates to a method to deink and/or to delaminate plastic material, for example plastic waste. The invention also relates to an installation to deink and/or to delaminate plastic material.

### BACKGROUND ART

Nowadays plastic packaging is abundantly used. The demand for plastic packaging continues to grow significantly due to the exceptional functional performance of plastic packaging, including among others, oxygen, moisture and light barrier properties, printability and food compliance. However, recycling rates of plastic packaging are still low.

Plastic packaging is typically heavily printed with inks, for example to provide information about the content and for marketing purposes to make them more appealing to consumers. Although inks are considered to be necessary components of plastic packaging, they are a significant source of contamination in plastic recycling. As all printed plastic films are generally collected and processed together, a low quality brownish, grayish or black recyclate is obtained, making it only suitable for downcycled products. The presence of ink also causes recycled films to be less stiff, weaker, and denser compared to the original material. Furthermore, during the processing or reprocessing, residual ink can decompose and produce gases causing rancid odor formation and also decrease the physical properties of a raw material. Hence, deinking of plastics could solve various problems and increase the quality, application potential, and price of the plastic waste.

Ink structures on plastic materials are chemically complex and comprise resins (15-50%), solvents (up to 65%), colorants (5-30%) and additives (up to 10%). The composition of an ink may differ considerably and is for example dependent on the printing process and on the substrate. For most substrates solvent-based inks in which the resin is dissolved in a suitable solvent are used as they allow sufficient wetting and adhesion. Water-based inks are generally used for substrates which can promote absorption mechanism such as paper and board. In addition to solvent and water-based inks where drying of inks is performed though evaporation of the liquid medium, in UV-based inks UV radiation is used for drying, which allows to ink to immediately form a three-dimensionally cross-linked film. UV-based inks require reactive resins such as acrylates which can react with free radicals created by UV radiation.

Plastic packaging is often a laminated structure of different polymer layers in order to increase their physico-chemical properties. Combination of functionality of each polymer provides plastic film with superior preservation performances such as among others, extended shelf life, high mechanical strength, good sealability. For example, sealing properties of PET are poor, thus it is often laminated with polyolefins. Similarly, use of aluminum layer provides protection against UV light, as such nutritional value of products are preserved for a longer time period.

Although the combination of different polymer layers extends the functionality and application area of plastic packaging, they make the recycling of multilayer packaging more complex. For example, during mechanical recycling, incompatibility issues may arise in the polymer blends due to their difference in physico-chemical properties, such as polyethylene (PE) and polyethylene terephthalate (PET). Similarly, in thermochemical recycling heterogeneous polymers such as PET, polyamide (PA), polycarbonate (PC) contaminate polyolefinic plastic waste. Therefore, multilayer plastic film fractions are still mainly incinerated or landfilled to date. In this respective, delamination comes in the picture as solution for multilayered packaging materials. By separating the different layers of a laminate structure, a more pure waste stream can be achieved in terms of polymer composition and, hence, increases recycling rates.

Although there is a high need for deinking and/or delamination processes, up to now industrial application of effective deinking procedures is limited.

Water-based liquid solutions comprising surfactants are known in the art to deink plastics (EP2832459 and EP1419829). Although water-based liquid solutions are easy to handle from safety perspective, treatments using such solutions are typically not able to deink all types of inks and/or all types of plastic films on the current market. These treatments usually work well on post-consumer and industrial film waste streams with well-defined compositions if the ink is on top of the monolayer or multilayer structure. However, a post-consumer waste stream typically comprises a mix of monolayer and multilayer films. For some plastic waste, the ink is between two layers. Especially for plastic films used in direct contact with food, the ink is usually covered by one or more layers in order to prevent leaching.

DE19651571 describes a method to recycle plastic material using ethyl acetate as extractant. This method only works for plastic material having ink on top of the monolayer or multilayer structure. This means that this method is not suitable to deink real (post-consumer) waste streams comprising plastic material having an ink layer protected by one or more polymer layers. For food-contact packaging material the ink layer is usually protected by one or more polymer layers in order to prevent any leaching. In addition, this method using ethyl acetate as extractant does not work to deink all type of inks, for example inks that do not dissolve for example because they are cross-linked. In particular a method using ethyl acetate does not work to deink UV-based inks even if they are on top of a monolayer or multilayer structure. UV-based inks are frequently used in packaging material since they offer many benefits such as lightfastness, resistance to smearing, glossiness and/or sharp contracts.

WO2021/198437 describes a method to deink plastic materials using an oxidizing inorganic acid. Although such method is efficient to deink different types of plastic material as such method uses an aggressive medium, many precaution are needed towards industrial application.

Deinking of monolayer or multilayer plastic material, for example monolayer or multilayer plastic waste remains challenging and there is a need for improved methods to delaminate. Furthermore, there is a need to provide a method allowing to delaminate and deink in one step.

### SUMMARY OF THE INVENTION

It is an object of the present invention to provide a method to deink and/or to delaminate plastic material such as plastic waste avoiding one or more of the drawbacks of the prior art.

It is an object of the present invention to provide a method to deink plastic material such as plastic waste avoiding one or more of the drawbacks of the prior art.

It is an object of the present invention to provide a method to delaminate plastic material such as plastic waste avoiding one or more of the drawbacks of the prior art.

It is also an object of the present invention to provide a method to deink and to delaminate plastic material such as plastic waste avoiding one or more of the drawbacks of the prior

It is also an object of the present invention to provide a method to deink and to delaminate plastic material in a single step.

It is another object of the present invention to provide a method that allows to deink and/or to delaminate and deink a wide variety of plastic material having different types of inks and/or including different types of multilayer plastic films, plastic material having ink on an outer surface as well as plastic material having ink covered by one or more layers, for example one or more polymer layer(s).

It is a further object of the present invention to provide a method to deink, or to delaminate and deink plastic material without causing neither dissolution nor degradation of the main plastic components of the polymer material.

It is a further object of the present invention to provide a method to deink, or to delaminate and deink plastic material that is efficient in removing annoying odours.

It is a further object of the present invention to provide a method that allows removing any type of inks from plastic material such as solvent-based inks, water-based inks and UV-based inks, either from monolayer or from multilayer plastic material.

It is a further object of the present invention to provide an economic viable method to deink plastic material or to delaminate and deink plastic material, in particular plastic waste.

It is a further object of the present invention to provide an installation to deink or to delaminate and deink plastic material, in particular plastic waste.

According to a first aspect of the present invention a method to deink and/or to delaminate plastic material, for example plastic waste, is provided. The method comprises the steps of
providing plastic material, comprising or provided with ink;
contacting the plastic material with at least one amine, as defined herein. The at least one amine comprises a nitrogen atom substituted with one, two or three hydrocarbon substituents. In case the nitrogen atom is substituted with two or three hydrocarbon substituents, these hydrocarbon substituents can be chosen independently from each other. At least one and preferably all of the hydrocarbon substituents of the nitrogen atom comprises an acyclic alkyl group or a cyclic alkyl group. The total number of carbon atoms of all hydrocarbon substituents of the nitrogen atom is at least 5.

In certain embodiments, the present invention is directed to a method to deink and/or delaminate plastic material, the method comprising the steps of:
providing plastic material, optionally comprising or provided with ink;
contacting the plastic material with a composition comprising at least one amine,
   wherein the at least one amine comprises a nitrogen atom substituted with one, two or three hydrocarbon substituents, with at least one of the hydrocarbon substituents comprising an acyclic alkyl group or a cyclic alkyl group, with the hydrocarbon substituents being chosen independently from each other in case the nitrogen atom is substituted with two or three hydrocarbon substituents and with the total number of carbon atoms of all hydrocarbon substituents of the nitrogen atom of the at least one amine being at least 5, and preferably at most 12, and wherein said composition comprises less than 0.010 weight % of a lactam, with weight % expressed based on the total weight of the composition.

The method according to the present invention may further comprise the step of
separating the thus obtained plastic material from the at least one amine, or from said composition comprising said at least one amine.

In certain embodiments of the present invention, a method is provided to deink plastic material, the method comprising the steps of:
providing plastic material, comprising or provided with ink;
optionally reducing the plastic material in size to obtain plastic material having a sieve diameter ranging between 0.01 cm and 20 cm;
contacting the plastic material with at least one amine, as defined herein, or with a composition as defined herein, comprising at least one amine as defined herein, and
optionally separating the thus obtained plastic material from the at least one amine or from said composition comprising said at least one amine.

In certain embodiments of the present invention, a method is provided to delaminate plastic material, the method comprising the steps of:
providing plastic material, optionally comprising or provided with ink;
optionally reducing the plastic material in size to obtain plastic material having a sieve diameter ranging between 0.01 cm and 20 cm;
contacting the plastic material with at least one amine, as defined herein, or with a composition as defined herein, comprising at least one amine as defined herein, and
optionally separating the thus obtained plastic material from the at least one amine or from said composition comprising said at least one amine.

In certain embodiments of the present invention, a method is provided to deink and delaminate plastic material, preferably in a single step, the method comprising the steps of:
providing plastic material comprising or provided with ink;
optionally reducing the plastic material in size to obtain plastic material having a sieve diameter ranging between 0.01 cm and 20 cm;
contacting the plastic material with at least one amine, as defined herein, or with a composition as defined herein, comprising at least one amine as defined herein, and
optionally separating the thus obtained plastic material from the at least one amine or from said composition comprising said at least one amine.

By bringing the plastic material in contact with at least one amine as specified above, or a composition as defined herein comprising said at least one amine, the plastic material is (i) deinked, (ii) delaminated, or (iii) deinked and delaminated. In preferred methods according to the present invention the plastic material is deinked and delaminated, preferably in a single step.

Although the applicant does not want to be bound by any theory, it seems that inks are very vulnerable to dissolution and/or aminolysis in the presence of an amine as specified above. By contacting the plastic material with such an amine, the polymer resin of the ink structures undergo dissolution and/or selective aminolysis while the other constituents of the polymer layer or polymer layers can be recovered without any dissolution and/or degradation.

Furthermore contacting a multilayered structure with an amine according to the present invention allows to swell the polymer layers of the multilayered structure. As the amine can diffuse through a polymer layer, inner layers of a multilayered structure can be reached. Consequently, contacting a multilayered structure with an amine according to the present invention, allows to delaminate multilayered structures.

Experimental results confirmed that the method according to the present invention results in deinking of plastic materials comprising or provided with different types of inks or with combinations of different types of inks. Experimental results also confirmed that the method according to the present invention results in deinking and/or delamination of different types of plastic material or combinations of plastic material such as multilayered structures of plastic material. Furthermore experimental results confirmed that the method according to the present invention results in deinking and delaminating of plastic materials comprising different types of inks or combinations of different types of inks and comprising different types of plastic material or combinations of plastic material such as multilayered structures of plastic material.

The method according to the present invention allows to deink plastic material comprising or provided with solvent-based inks as for example inks comprising nitrocellulose based resins, polyurethane based resins, polyvinylchloride based resins, ethyl cellulose based resins, cellulose acetate propionate based resins, cellulose acetate butyrate based resins, polyvinyl butyral based resins, polyacrylate based resins, polyamide based resins, and combinations thereof.

The method according to the present invention also allows to deink plastic material comprising or provided with water-based inks as for example inks comprising acrylate based resins, maleics based resins or combinations thereof.

The method according to the present invention also allows to deink plastic material comprising or provided with offset inks as for example modified rosin resins, in particular phenolic modified rosin resins, alkyd based resins and combinations thereof.

The method according to the present invention also allows to deink plastic material comprising or provided with ultraviolet curable (UV) and/or electron beam (EB) curable resins as for example acrylate based resins, for example epoxy acrylate based resins.

An important advantage of the method according to the present invention is that it allows to deink plastic material comprising or provided with different types of inks, for example with solvent-based inks, water based inks, offset inks, UV and/or EB curable inks and any combination thereof.

Furthermore, experimental results confirmed that the method according to the present invention results in deinking and delamination of different types of plastic materials such as plastic waste, either plastic materials comprising a monolayer or multilayered polymer structure, including different types of multilayered polymer structures having ink on an outer surface as well as having ink covered by one or more layers, for example one or more polymer layer.

Deinking and/or delaminating can be further improved by applying shear on the plastic material while or after contacting the plastic material with the amine or a composition comprising said amine as described herein. Shear can be applied by any method known in the art, for example by stirring, mixing or agitating. Any type of stirring, mixing or agitating known in the art can be considered. For the purpose of the present invention the terms ‘stir’, ‘mix’ and ‘agitate’ can be used interchangeably.

An example of stirring comprises stirring in a continuous stirred tank reactor (CSTR) using a rotating agitator with a rotation speed of for example at least 100 rpm (revolutions per minute), at least 250 rpm, at least 300 rpm or at least 500 rpm. Alternatively or additionally, other methods to induce shear can be considered as well.

In preferred embodiments of the present methods, the plastic material is reduced in size, preferably before being contacted with the amine or with the composition, as described herein comprising said amine. The reduction in size can be obtained by any technique known in the art, for example by milling, shredding, grinding and/or comminuting. The plastic material is preferably reduced in size to obtain plastic material having a sieve diameter between 0.01 cm and 20.00 cm, for example between 0.01 cm and 10.00 cm, or between 0.10 cm and 4.00 cm, or between 0.50 cm and 4.00 cm. The indicated ranges favour a more efficient deinking and/or delamination process. The term ‘sieve diameter’ refers to the size of a sieve opening (the width of a square aperture) through which a particle will pass.

The method to deink and/or to delaminate according to the present invention may comprise a continuous or discontinuous (batch) process. In a continuous process the plastic material, the at least one amine or both the plastic material and the at least one amine can be continuously introduced. In preferred methods, the at least one amine is reintroduced to contact the plastic material. The at least one amine is for example reintroduced after being separated from the plastic material in the separating step, to contact the plastic material in the contacting step by means of a looping system.

### DESCRIPTION OF EMBODIMENTS

The present invention will be described with respect to particular embodiments but the invention is not limited thereto but only by the claims.

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the above passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while certain embodiments described herein include some but not other features included in other embodiments, combinations of features of different embodiments are meant to be within the scope of the invention, and form different embodiments, as would be understood by those in the art.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

When referring to the endpoints of a range, the endpoints values of the range are included. The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g. from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %,” “vol %”, or “mol %” refers to a weight percentage of a component, a volume percentage of a component, or molar percentage of a component, respectively, based on the total weight, the total volume of material, or total moles, which includes the component. The term “wt %” and “weight %” are used as synonyms herein.

When describing the invention, the terms used are construed in accordance with the following definitions, unless indicated otherwise.

The term ‘and/or’ when listing two or more items, means that any one of the listed items can by employed by itself or that any combination of two or more of the listed items can be employed. The terms ‘first’, ‘second’ and the like used in the description as well as in the claims, are used to distinguish between similar elements and not necessarily describe a sequence, either temporally, spatially, in ranking or in any other manner. It is to be understood that the terms so used are interchangeable under appropriate circumstances and that the embodiments of the invention described herein are capable of operation in other sequences than described or illustrated herein.

In an embodiment, the present invention relates to a method to deink and/or delaminate plastic material, the method comprising the steps of:
providing plastic material, optionally comprising or provided with ink; and
contacting the plastic material with at least one amine, or a composition comprising at least one amine, wherein the at least one amine comprises a nitrogen atom substituted with one, two or three hydrocarbon substituents, with at least one of the hydrocarbon substituents comprising an acyclic alkyl group or a cyclic alkyl group, with the hydrocarbon substituents being chosen independently from each other in case the nitrogen atom is substituted with two or three hydrocarbon substituents and with the total number of carbon atoms of all hydrocarbon substituents of the nitrogen atom of the at least one amine being at least 5, and preferably at most 12.

A particular method according to the present invention comprises the following steps:
providing plastic material, optionally comprising or provided with ink,
reducing the polymer material in size to obtain plastic material having a sieve diameter between 0.01 cm and 20.00 cm, for example between 0.01 cm and 10.00 cm or between 0.10 cm and 4.00 cm or between 0.50 cm and 4.00 cm;
contacting the plastic material with at least one amine, as defined herein, or with a composition as defined herein. The at least one amine comprises a nitrogen atom substituted with one, two or three hydrocarbon substituents. In case the nitrogen atom is substituted with two or three hydrocarbon substituents, these hydrocarbon substituents can be chosen independently from each other. At least one and preferably all of the hydrocarbon substituents of the nitrogen atom comprises an acyclic alkyl group or a cyclic alkyl group. The total number of carbon atoms of all hydrocarbon substituents of the nitrogen atom is at least 5. Preferably the total number of carbon atoms of all hydrocarbon substituents of the nitrogen atom is at most 12.
optionally, separating the thus obtained plastic material from the amine or from said composition.

As mentioned above according to the present invention the plastic material is contacted with at least one amine. It is clear that the method according to the present invention may comprise the use of more than one amine,. In case more than one amine is used, the amines can be used in one step for example by contacting the plastic material with a mixture of a first amine and a second amine or in subsequent step, for example by contacting the plastic material first with a first amine and subsequently with a second amine.

In certain embodiments of the present invention, a plastic material as defined herein is contacted with an amine, whereby such amine is as a single component, preferably used in a relative pure form, e.g. having a purity of at least 98.0% w/w, or at least 99.0% w/w, or at least 99.5% w/w.

In certain embodiments of the present invention, a plastic material as defined herein is contacted with a composition comprising the amine(s) as defined herein. Thus, in certain embodiments of the present invention the at least one amine as defined herein may be present in a composition comprising other components, e.g. water, organic solvents, alcohols, etc. The term “composition” as used herein may refer to a mixture, solution or dispersion of the at least one amine in another component(s), such as in one or more liquid components as defined herein.

In some embodiments of the present invention, a plastic material as defined herein is contacted with a composition comprising the at least one amine, and wherein said composition comprises less than 0.010 weight % of a lactam, with weight % expressed based on the total weight of the composition. Preferably, said composition comprises less than 0.009 wt %, or less than 0.008 wt %, or less than 0.005 wt %, or less than 0.003 wt %, or less than 0.001 wt %, with wt % expressed based on the total weight of the composition. In some embodiments of the present invention, a plastic material as defined herein is contacted with a composition comprising the at least one amine, wherein said composition comprises less than 100 ppm of a lactam, with ppm expressed based on the total weight of the composition. Preferably, said composition comprises less than 90 ppm, or less than 80 ppm, or less than 70 ppm, or less than 60 ppm, or less than 50 ppm, or less than 40 ppm, or less than 30 ppm, or less than 20 ppm or less than 10 ppm of a lactam, with ppm expressed based on the total weight of the composition. Lactams can be detected using methods that are known by the skilled person, such as by means of GC-MS or HPLC analytical techniques.

In particularly preferred embodiment of the present invention, a plastic material as defined herein is contacted with a composition comprising the at least one amine, as defined herein, wherein said composition does not comprise any lactam. In other words, in a particularly preferred embodiment of the present invention, the composition a plastic material as defined herein is contacted with a composition comprising the at least one amine, as defined herein, wherein said composition is lactam-free, i.e. it does not contain any lactam.

The term “lactam” is well known in the art and refers to a cyclic amide. The term “lactam” as used herein intends to cover this component in its broadest sense: it is including unsubstituted and substituted lactams, e.g. lactams that are substituted on the nitrogen in the ring. The term “lactam” may also encompass an oligomer of the lactam, such as a cyclic oligomer. The term “lactam” may also encompass an oligomer of the lactam which can be a dimer, trimer, tetramer, pentamer of hexamer of lactam. Non-limiting examples of lactam, that are excluded from a composition as defined herein, or—if present—only in minimal amounts as defined herein, are for instance β-lactam, γ-lactam, δ-lactam and ε-lactam, 2-azetidinone, γ-butyrolactam, 2-piperidinone (or δ-valerolactam), ε-caprolactam caprylolactam, and 1,8-diaxacyclodecane-2,9-dione.

The inventors have found that deinking and/or delamination can occur with no depolymerization, no dissolution and/or no degradation of the plastic material by using methods according to the inventions.

It has been found that the presence of a lactam in a composition as defined herein may have unwanted side effects on the deinking and/or delamination process of plastic materials. For example, some polymers may degrade in the presence of lactam or in the presence of too high concentrations of lactam; some polymers may at least partially depolymerize in the presence of lactam or in the presence of too high concentrations of lactam. Lactams can cause the dissolution of polymers too. Avoiding or reducing the amounts of lactam in a composition as defined herein, further advantageously avoids contamination of the recycled polymer by polyamide, which may be formed via ring opening polymerization during the method. Also, lactams have the disadvantage that they have generally high boiling points, thus their recovery is an energy intensive process, and their use is to be avoided.

In some embodiments of the present invention a method to deink and/or delaminate plastic material is provided wherein the method comprising the steps of:
providing plastic material, optionally comprising or provided with ink;
contacting the plastic material with a composition comprising at least one amine,
   wherein the at least one amine comprises a nitrogen atom substituted with one, two or three hydrocarbon substituents, with at least one of the hydrocarbon substituents comprising an acyclic alkyl group or a cyclic alkyl group, with the hydrocarbon substituents being chosen independently from each other in case the nitrogen atom is substituted with two or three hydrocarbon substituents and with the total number of carbon atoms of all hydrocarbon substituents of the nitrogen atom of the at least one amine being at least 5, and preferably at most 12, and wherein said composition comprises less than 0.010 weight % of a lactam, with weight % expressed based on the total weight of the composition, and preferably does not comprise any lactam.

In some embodiments of the present methods of the invention, the composition comprising the at least one amine is a non-eutectic composition. Hence, in some embodiments of the present methods of the invention, the composition comprising the at least one amine is a non-eutectic composition. An “eutectic composition” or “eutectic mixture” is well known in the art, and refers to a homogenous mixture of substances that melts or solidifies at a single temperature that is lower than the melting point of any of the constituents. Thus, in preferred embodiments of the present invention, delamination/deink is succeeded without using or creating an eutectic mixture. Eutectic mixtures are typically composed of based H bond donor and acceptor ability of 2 compounds. In the present invention, amine(s) are used. For example, when combining the amine(s) with a liquid component, the mechanism of delamination may be based on swelling of polymer film. For example, amines may be used in combination with alkanes. Alkanes do not have H bonding ability.

In certain embodiments of the present invention, the plastic material is contacted with a composition comprising (A) said at least one amine as defined herein, and (B) a liquid component, wherein said liquid component is selected from the group comprising
(b1) water,
(b2) a hydrocarbon, preferably a hydrocarbon as defined herein,
(b3) an alcohol, preferably an alcohol as defined herein,
(b4) an organic solvent, wherein the organic solvent is different from said hydrocarbon of (b2) and said alcohol of (b3), preferably a organic solvent as defined herein,
(b5) a solution of an inorganic salt or an inorganic base, preferably a organic solves as defined herein, and
(b6) any mixtures of the (b1) to (b5).

In certain embodiments of the present invention, the plastic material is contacted with a composition comprising (A) said at least one amine as defined herein, and (B) a liquid component, wherein said liquid component is selected from the group comprising
(b1) water,
(b2) a hydrocarbon, preferably a hydrocarbon as defined herein,
(b3) an alcohol, preferably an alcohol as defined herein,
(b4) an organic solvent, wherein the organic solvent is different from said hydrocarbon of (b2) and said alcohol of (b3), preferably a organic solvent as defined herein,
(b5) a solution of an inorganic salt or an inorganic base, preferably a organic solves as defined herein, and
(b6) any mixtures of the (b1) to (b5),
   and wherein said composition comprises less than 0.010 weight % of a lactam, with weight % expressed based on the total weight of the composition, and preferably, less than 0.009 wt %, or less than 0.008 wt %, or less than 0.005 wt %, or less than 0.003 wt %, or less than 0.001 wt %, with wt % expressed based on the total weight of the composition, and more preferably does not comprise any lactam.

In certain embodiments, the present invention, the plastic material is contacted with a composition comprising (A) said at least one amine, and (B) a liquid component, wherein said liquid component (B) is selected from the group comprising (b1) water; (b2) a hydrocarbon, preferably an alkane, preferably a C5-C12 alkane; (b3) an alcohol; (b4) an organic solvent which is different from the hydrocarbon in (b2) and the alcohol in (b3), and preferably selected from the group comprising acetone, acetonitrile, benzene, 2-butanone, carbon tetrachloride, chlorobenzene, chloroform, 1,2-dichloroethane, diethyl ether, diethylene glycol dimethyl ether, 1,2-dimethoxy-ethane (DME), dimethyl-formamide sulfoxide (DMSO), 1,4-dioxane, ethyl acetate, hexamethylphosphoramide (HMPA), hexamethylphosphorous triamide (HMPT), methyl t-butyl ether (MTBE), methylene chloride, nitromethane, petroleum ether, pyridine, tetrahydrofuran (THF), toluene, o-xylene, m-xylene, p-xylene, and any mixtures thereof; (b5) a solution of an inorganic salt or an inorganic base, preferably an aqueous solution of an inorganic salt or an inorganic base; and, (b6) any mixtures of (b1) to (b5).

In certain embodiments of the present invention, the ratio of the volume of the amine(s) over the volume of the liquid component in said composition is comprised between 1/99 to 99/1, such as between 5/95 and 95/5, or between 10/90 and 90/10, or between 25/75 and 75/25, or between 40/60 and 60/40, such as about 50/50.

In certain embodiments of the present invention the total amount of said amines in said composition is at least 1.0 vol %, or at least 5.0 vol %, or at least 10.0 vol %, or at least 20.0 vol %, or at least 25.0 vol %, or at least 40.0 vol %, or at least 60.0 vol %, or at least 75.0 vol %, or at least 80.0 vol %, or at least 90.0 vol %, or at least 95.0 vol %, with vol % as compared to the volume of the composition. “Total amount” refers to the sum of all amounts of all amines in said composition.

In certain embodiments of the present invention, the total amount of said amine(s) in said composition is at least 98.0 weight %, or at least 98.5% weight %, or at least 99.0 weight %, or at least 99.5 weight %, or at least 99.9 weight %, with weight % based on the total weight of said composition.

In some preferred embodiments of the present invention, a composition as used herein comprises at least one amine as defined herein and water.

In some embodiments, a composition comprising at least one amine as used herein comprises at most 75.0 vol %, or most 60.0 vol %, or at most 50.0 vol %, or at most 40.0 vol %, or at most 30.0 vol %, or at most 25.0 vol %, or at most 20.0. vol %, or at most 10.0 vol %, or at most 5.0 vol %, or at most 1.0 vol % of water, with vol % expressed as compared to the volume of the composition. In some embodiments, a composition comprising at least one amine as used herein comprises at least 1.0 vol %, or at least 5.0 vol %, or at least 10.0 vol %, or at least 20.0 vol %, or at least 25.0 vol %, or at least 30.0 vol %, or at least 40.0 vol % of water, or at least 50.0 vol % of water, or at least 60.0 vol % of water, or at least 75.0 vol % of water, with vol % as compared to the volume of the composition. In certain embodiments of the present invention, a composition as used herein consists of one or more amine(s) as defined herein and water. In other words, in certain embodiments of the present method, the sole components in a composition as used herein include amine(s), as defined herein, and water.

In some embodiments, the amine may be mixed with water and/or a hydrocarbon, e.g. an alkane to form a composition as used herein. As water may be immiscible with the amine, harsh stirring is needed in some embodiments.

In some preferred embodiments of the present invention, a composition as used herein comprises at least one amine as defined herein and a hydrocarbon as liquid component. It will be understood in the context of the invention that also mixtures of hydrocarbons may be used as liquid components in the present compositions.

When used in reference to the liquid component, the term “hydrocarbon” refers to an organic compound consisting of the elements hydrogen and carbon. Preferred hydrocarbons for use in a composition of the present invention are alkanes. The term “alkanes” is known to refer to organic compounds comprising carbon atoms and hydrogen atoms, and wherein the bonds between carbon atoms are single bonds. Alkanes comprise cycloalkanes (cyclic alkanes) and acyclic alkanes. Acyclic alkanes include linear alkanes and branched alkanes. In some embodiments of the present invention, cycloalkanes are preferred over acyclic alkanes. Advantageous, cycloalkanes may show a high diffusion rate through apolar polymer layers, as for example through polypropylene or polyethylene polymer layers, which can facilitate the processes of the invention.

In some embodiments, the alkane(s) present in a composition of the invention has (have) at most 12 carbon atoms, or at most 10 carbon atoms, or at most 8 carbon atoms, or at most 6 carbon atoms, or at most 5 carbon atoms. In some embodiments, alkanes having 5 to 12 carbon atoms including all their isomers and stereoisomers, are preferred.

In some embodiments, the alkanes are C6 to C8 alkanes, such as acyclic C6 to C8 alkanes. Non-limiting examples of alkanes for use in the present invention are selected from the group comprising n-hexane, 2-methyl pentane, 3-methyl pentane, 2,2-dimethyl butane, 2,3-dimethyl butane, n-heptane, 2-methylhexane, 3-methylhexane, 2,2-dimethylpentane, 2,3-dimethylpentane, 2,4-dimethylpentane, 3-3-dimethylpentane, 3-ethyl-pentane, 2,2,3-trimethylbutane, n-octane, 2-methylheptane, 2-methylheptane, 3-methylheptane (including 2 enantiomers), 4-methylheptane, 3-ethylhexane, 2,2-dimethylhexane, 2,3-dimethylhexane (including 2 enantiomers), 2,4-dimethylhexane (including 2 enantiomers), 2,5-dimethylhexane, 3,3-dimethylhexane, 3,4-dimethylhexane (including 2 enantiomers and 1 meso compound), 3-ethyl-2-methylpentane, 3-ethyl-3-methylpentane, 2,2,3-trimethylpentane (including 2 enantiomers), 2,2,4-trimethylpentane, 2,3,3-trimethylpentane, 2,3,4-trimethylpentane and 2,2,3,3-tetramethylbutane. Particularly preferred alkanes may include, but are not limited to alkanes such as hexane, heptane and octane including all their isomers and stereoisomers.

In some embodiments, the alkanes are cycloalkanes. As used herein “cycloalkanes” refer to compounds that comprise a ring-shaped structure of sp3 hybridized carbon atoms. Cycloalkanes as used herein may comprise monocyclic alkanes (comprising one ring structure), either substituted or non-substituted, and polycyclic alkanes (comprising more than one ring structure), for example bicyclic alkanes (comprising two ring structures), either substituted or non-substituted.

In some preferred embodiments, cycloalkanes having 5 to 12 carbon atoms are preferred. In some embodiments, cycloalkanes having a ring of 5 to 12 carbon atoms are preferred. Suitable examples of monocyclic alkanes comprise cyclopentane either substituted or non-substituted, for example cyclopentane, methyl-cyclopentane, ethyl-cyclopentane, methylethyl-cyclopentane, dimethyl-cyclopentane, diethyl-cyclopentane; cyclohexane, either substituted or non-substituted, for example cyclohexane, methyl-cyclohexane, ethyl-cyclohexane, methylethyl-cyclohexane, dimethyl-cyclohexane, diethyl-cyclohexane. Examples of bicyclic alkanes comprise for example bicyclo[2.2.0]hexane, bicyclo[2.1.1]hexane, bicyclo[2.2.1]heptane, bicyclo[4.4.0]decane and bicyclo[4.3.1]decane. Particularly preferred cycloalkanes may include cyclopentane, cyclohexane, cycloheptane or cyclooctane, each one being either substituted or non-substituted.

In some embodiments of the present invention, a composition as used herein comprises at least one amine as defined herein and an alcohol as liquid component. It will be understood in the context of the invention that also mixtures of alcohols may be used as liquid components in the present compositions.

Preferably, in certain embodiments, said alcohol is an alcohol according to the formula R*—OH, wherein R* is an alkyl group, optionally substituted by one or more substituents selected from the group consisting of halogen, hydroxyl, and alkyl. The term “alkyl” as used herein means normal, secondary, or tertiary, linear, branched or straight hydrocarbons with no site of unsaturation. In particular embodiments, the term alkyl refers to C₁₋₁₂alkyl, for instance C₁₋₁₀alkyl, or C₁₋₈alkyl, or C₁₋₆alkyl, or C₁₋₄alkyl. Preferably, the alcohol is selected from the group comprising methanol, ethanol, 1-propanol, 2-propanol, 1-butanol, 2-butanol, 2-methyl-1-propanol, 2-methyl-2-propanol, 1-pentanol, 3-methyl-1-butanol, 2,2-dimethyl-1-propanol, cyclopentanol, 1-hexanol, cyclohexanol, 1-heptanol, 1-octanol, 1-nonanol, 1-decanol, 2-propen-1-ol, phenylmethanol, diphenylmethanol, triphenylmethanol and any mixtures thereof. In certain preferred embodiments, the alcohol is selected from methanol, ethanol, a propanol, and a butanol and any mixtures thereof. In an example, the alcohol is ethanol, a propanol or a butanol.

In some embodiments, a composition comprising at least one amine as used herein comprises at most 75.0 vol %, or at most 60.0 vol %, or at most 50.0 vol %, or at most 40.0 vol %, or at most 30.0 vol %, or at most 25.0 vol %, or at most 20.0. vol %, or at most 10.0 vol %, or at most 5.0 vol %, or at most 1.0 vol % of alcohol, with vol % expressed as compared to the volume of the composition. In some embodiments, a composition comprising at least one amine as used herein comprises at least 1.0 vol %, or at least 5.0 vol %, or at least 10.0 vol %, or at least 20.0 vol %, or at least 25.0 vol %, or at least 30.0 vol %, or at least 40.0 vol % or at least 50.0 vol %, or at least 60.0 vol %, or at least 75.0 vol %, of alcohol, with vol % as compared to the volume of the composition. In certain embodiments of the present invention, a composition as used herein consisting of one or more amine(s) as defined herein and one or more alcohols.

In some embodiments of the present invention, a composition as used herein comprises at least one amine as defined herein and an organic solvent as liquid component. Preferably said organic solvent is different from a hydrocarbon and an alcohol as defined herein. It will be understood in the context of the invention that also mixtures of organic solvents may be used as liquid components in the present compositions. It will be understood in the context of the present invention that the term “organic solvent” as used herein does not include any lactam.

Preferred examples of organic solvent(s) for use in the present composition may be selected from the group comprising acetone, acetonitrile, benzene, 2-butanone, carbon tetrachloride, chlorobenzene, chloroform, 1,2-dichloroethane, diethyl ether, diethylene glycol dimethyl ether, 1,2-dimethoxy-ethane (DME), dimethyl-formamide (DMF), dimethyl sulfoxide (DMSO), 1,4-dioxane, ethyl acetate, hexamethylphosphoramide (HMPA), hexamethylphosphorous triamide (HMPT), methyl t-butyl ether (MTBE), methylene chloride, nitromethane, petroleum ether, pyridine, tetrahydrofuran (THF), toluene, o-xylene, m-xylene, p-xylene, and any mixtures thereof. One advantage of using a solvent in the present invention may be that when there is a diffusion lag for the amine, such solvent would be able to disentangle the polymer slightly.

In some embodiments, a composition comprising at least one amine as used herein comprises at most 75.0 vol %, or at most 60.0 vol %, or at most 50.0 vol %, or at most 40.0 vol %, or at most 30.0 vol %, or at most 25.0 vol %, or at most 20.0. vol %, or at most 10.0 vol %, or at most 5.0 vol %, or at most 1.0 vol % of organic solvent, with vol % expressed as compared to the volume of the composition. In some embodiments, a composition comprising at least one amine as used herein comprises at least 1.0 vol %, or at least 5.0 vol %, or at least 10.0 vol %, or at least 20.0 vol %, or at least 25.0 vol %, or at least 30.0 vol %, or at least 40.0 vol %, or at least 50.0 vol %, or at least 60.0 vol %, or at least 75.0 vol %, of organic solvent, with vol % as compared to the volume of the composition. In certain embodiments of the present invention, a composition as used herein consists of one or more amine(s) as defined herein and one or more organic solvents.

In some embodiments of the present invention, a composition as used herein comprises at least one amine as defined herein and an inorganic salt or an inorganic base, preferably provided as a solution of said inorganic salt or an inorganic base, such as an aqueous solution thereof (i.e. a solution of the inorganic salt or base in water).

In some embodiments, a composition as used herein may comprise at most 5.0 weight %, preferably at most 4.0 weight %, preferably at most 3.0 weight %, preferably at most 2.5 weight %, preferably at most 2.0 weight %, preferably at most 1.0 weight %, preferably at most 0.5 weight % of a salt or a base, preferably an inorganic salt or an inorganic base, with weight % based on the (total) weight of the composition. In some embodiments, a composition as used herein may comprises at least 0.1 weight %, preferably at least 0.5 weight %, preferably at least 1.0 weight %, preferably at least 2.0 weight %, preferably at least 2.5 weight %, preferably at least 3.0 weight %, preferably at least 4.0 weight %, preferably at least 4.5 weight %, preferably at least 5.0 weight % of a salt or a base, preferably an inorganic salt or an inorganic base, with weight % based on the (total) weight of the composition.

In some embodiments, the base is selected from the group comprising potassium hydroxide (KOH), lithium hydroxide (LiOH), sodium hydroxide (NaOH), rubidium hydroxide (RbOH), Magnesium Hydroxide Mg(OH)₂, Barium Hydroxide Ba(OH)₂, calcium hydroxide (Ca(OH)₂), strontium hydroxide (Sr(OH)) and any mixtures thereof. Preferably, the base is potassium hydroxide (KOH), or sodium hydroxide (NaOH).

An amine is defined as a compound comprising a (basic) nitrogen atom with a lone pair.

The at least one amine used in the method according to the present invention comprises a nitrogen atom substituted with one, two or three hydrocarbon substituents. At least one of the hydrocarbon substituents of the nitrogen atom comprises an acyclic alkyl group or a cyclic alkyl group. Preferably, all the hydrocarbon substituents comprise an acyclic alkyl group or a cyclic alkyl group. The total number of carbon atoms of all hydrocarbon substituents of the nitrogen atom is at least 5.

The at least one amine used in the method according to the present invention may comprise a primary amine whereby the nitrogen atom has one hydrocarbon substituent, a secondary amine whereby the nitrogen atom has two hydrocarbon substituents which can be either the same or different or a tertiary amine whereby the nitrogen atom has three hydrocarbon substituents which can be either the same or different. The at least one amine may also comprise more than one amine functional groups, for example two amine functional groups (diamines).

A hydrocarbon substituent or radical is defined as a hydrocarbon compound in which one or more hydrogen atom(s) have been removed.

A hydrocarbon compound is an organic compound comprising mainly carbon and hydrogen. A hydrocarbon compound may comprise one or more nitrogen atoms, for example one or more amine functional groups. Preferred hydrocarbon compounds consist entirely of carbon and hydrogen.

Preferred hydrocarbon substituents consist of carbon and hydrogen and do not comprise heteroatoms such as oxygen.

The hydrocarbon substituents are preferably directly bonded to the nitrogen atom of the amine.

The hydrocarbon substituents of the amine used in the method according to the present invention are preferably apolar, saturated hydrocarbon substituents.

A hydrocarbon substituent has preferably 1, 2, 3, 4, 5 or 6 carbon atoms, although hydrocarbon substituent having a higher number of carbon atoms can be considered as well.

In certain embodiments of the present invention, the amine is a mono-amine. The use of a mono-amine as compared to a polyamine is preferred and may be advantageous, as the diffusion of a polyamine, through polymer layers, may be slower in view of its long chain, resulting in a decrease in the delamination rate. In certain embodiments, every hydrocarbon substituent of the amine, which is preferably a mono-amine, has at most 7 carbon atoms, preferably at most 6 carbon atoms, preferably at most 5 carbon atoms, preferably at most 4 carbon atoms. Amines comprising longer hydrocarbon substituents are less preferred in the present invention. Basicity of an amine may (slightly) decrease with increasing (alkyl) chain length. Also, longer (alkyl) chains limit diffusion of the amines, which adversely affects delamination rate. Also, with increasing (alkyl) chain length, the boiling temperature of the amine increases, making recovery of the amine a more energy demanding process.

In some embodiments, the amine comprises a single nitrogen atom, substituted with one or two hydrocarbon substituents wherein the one or the two hydrocarbon substituents, each have at most 7 carbon atoms.

In some embodiments, an amine as used herein is an amine according to formula (I):

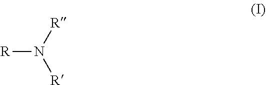

wherein R is an acyclic alkyl group or a cyclic alkyl group, comprising n carbon atoms;
wherein R′ is: —H; or, an acyclic alkyl group or a cyclic alkyl group, comprising m carbon atoms;
wherein R″ is: —H; or, an acyclic alkyl group or a cyclic alkyl group, comprising p carbon atoms;
wherein n+m+p is at least 5, and preferably at most 12, preferably at most 10, preferably at most 8, preferably at most 7, preferably at most 6.

In some embodiments, n, m and p are each at most 7, preferably at most 6, preferably at most 5, preferably at most 4, preferably at most 3.

In some embodiments, an amine as used herein is an amine according to formula (I),
wherein R is an acyclic alkyl group or a cyclic alkyl group, comprising n carbon atoms;
wherein R′ is: —H; or, an acyclic alkyl group or a cyclic alkyl group, comprising m carbon atoms;
wherein R″ is: —H; and, wherein n+m is at least 5, and preferably at most 12, preferably at most 10, preferably at most 8, preferably at most 7, preferably at most 6.

In some embodiments, an amine as used herein is an amine according to formula (I), wherein R is an acyclic alkyl group or a cyclic alkyl group, comprising n carbon atoms; wherein R′ is: —H; wherein R″ is: —H; and, wherein n is at least 5, and preferably at most 12, preferably at most 10, preferably at most 8, preferably at most 7, preferably at most 6.

The total number of carbon atoms of all hydrocarbon substituents of the nitrogen atom is at least 5. The total number of carbon atoms refers to the sum of the number of carbon atoms of the first hydrocarbon substituent, the number of carbon atoms of the second hydrocarbon substituent (if present) and the number of carbon atoms of the third hydrocarbon substituent (if present).

Preferably, the total number of carbon atoms of the different hydrocarbon substituents ranges between 5 and 12, and is for example 6, 7, 8 or 10.

Preferably, the at least one amine is a mono-amine. As used herein the term “mono-amine” is an amine comprising only a single amine functionality in the molecule.

Preferably, the at least one amine used in the method according to the present invention has a sufficiently high basicity.

As secondary amines are more basic than primary and tertiary amine, secondary amines may be preferred in the method according to the present invention.

Unsaturated hydrocarbon substituents such as aryl diminish the basicity of the amine. Therefore amines having apolar, saturated hydrocarbon substituents are preferred in the method according to the present invention.

The hydrocarbon substituent preferably comprises an acyclic alkyl group or a cyclic alkyl group. An acyclic alkyl group can be substituted, for example with one or more alkyl groups (either branched or non branched). An acyclic alkyl group is for example substituted with one or more methyl, ethyl and/or propyl groups. An acyclic alkyl group can be branched or non-branched. A cyclic alkyl group can be substituted, for example with one or more acyclic alkyl groups, either branched or non-branched. A cyclic alkyl group is for example substituted with one or more methyl, ethyl and/or propyl groups.

Preferred hydrocarbon substituents comprise acyclic or cyclic alkyls such as methyl, ethyl, propyl, butyl, pentyl, hexyl, heptyl, octyl, cyclo-propyl, cyclo-butyl, cyclo-pentyl, cyclo-hexyl, cyclo-heptyl and cyclo-octyl, either substituted or non-substituted.

Examples of branched alkyls comprise isobutyl and 2-methyl-3-propyl. Examples of substituted cyclo-alkyls comprise methyl-cyclo-alkyls or ethyl-cyclo-alkyls, for example methyl-cyclo-hexyl or ethyl-cyclo-hexyl.

Examples of primary amines comprise pentylamine, hexylamine, heptylamine, octylamine, cyclo-pentyl amine, cyclo-hexyl amine, cyclo-heptyl amine, cyclo-octyl amine, isobutylamine, isopentyl amine, isohexylamine and 3-methyl-2-hexylamine.

Other examples of primary amines comprise diamines such as pentane diamine, hexane diamine, heptane diamine and octane diamine. Particular examples comprise 1,5-pentane diamine, 2,4-pentane diamine, 1,6-hexane diamine, 2-methyl-3-propylhexane-1,3-diamine, 2-methyl-1,5-diaminopentane and 2-methyl-1,8-octanediamine.

Examples of secondary amines comprise N-ethyl N-butyl amine, N-ethyl N-propyl amine, N-butyl methyl amine, N-ethylpentylamine, dipropyl amine, dibutyl amine; dipentyl amine, dihexyl amine, butyl isopropyl amine, ethyl isobutyl amine, N-ethyl-2-methylhexane-3-amine.

Although less preferred, secondary amines comprising more than one, for example two cyclic alkyl groups can be considered as well.

Examples of tertiary amines comprise triethyl amine, tripropyl amine, tributyl amine, diethylbutylamine, diethyl(pentyl)amine, butyl(ethyl)methylamine, N-ethyl-N-methylpropan-2-amine ethylisobutylmethylamine and N,N-dimethyl cyclo-hexyl amine.

Although less preferred, tertiary amines comprising more than one, for example two or three cyclic alkyl groups can be considered as well.

Although the invention is not limited thereto, particularly good deinking and delamination of plastic material is obtained by contacting the plastic material with a secondary aliphatic non-branched amine as for example N-ethyl-N-butyl amine.

According to the present invention, the amine can be used pure, i.e. in a concentration of at least 98 wt % or in a concentration of at least 99 wt %. The amine can also be used in a mixture, solution or dispersion. The at least one amine is for example present in a mixture, solution or dispersion in a concentration of at least 1 wt %. More preferably, the at least one amine is present in the mixture, solution or dispersion in a concentration is higher for example at 20 wt %, at least 30 wt % or at least 40 wt % or at least 50 wt %. In case more than one amine is used, the concentration of amine corresponds with the sum of the concentrations of the different amines.

It is clear that the mixture, solution or dispersion comprising the at least one amine may comprise further components as for example one or more surfactant or catalyst. A surfactant is for example added to improve the wetting of the polymer material. A catalyst is for example added to promote potential aminolysis reactions.

In preferred methods of the present invention, the plastic material is contacted with the at least one amine or with a composition as described herein that comprises the at least one amine at a temperature of at least 20° C., preferably at least 25° C., preferably at least 30° C., preferably at least 35° C., preferably at least 40° C. preferably at least 50° C., at a temperature of at least 60° C., at a temperature of at least 70° C., at a temperature of at least 80° C., at a temperature of at least 100° C. It is clear that the temperature should be lower than the melting temperature of the plastic material. To reach the required temperature the amine can be heated.

In some embodiments, the temperature at which the plastic material is contacted with the at least one amine or with a composition as described herein that comprises the at least one amine, is kept below the meting point of lowest melting polymer in the plastic material, preferably at least 2° C., preferably at least 5° C., preferably at least 10° C., below the melting point of the lowest melting polymer in the plastic material. It has been found that higher temperatures may favour an efficient delamination process, however the temperature is limited by the melting point of the components involved.

In some embodiments, the plastic material is contacted with the at least one amine or with a composition as described herein that comprises the at least one amine at a temperature of at least 20° C. to at most 120° C., preferably at least 25° C. to at most 100° C., preferably at least 25° C. to at most 80° C., preferably at least 25° C. to at most 65° C.

The concentration of the amine and/or the temperature of the amine may influence the efficiency of the deinking and/or delaminating method.

In some embodiments, the plastic material is contacted with the at least one amine or with the composition comprising said at least one amine for a suitable period of time, for instance at least for 5 minutes, or at least for 10 minutes, or for instance for a period ranging from 10 minutes to 2 hours, or from 20 minutes to 2 hours.

The method can be conducted under inert atmosphere, for example under nitrogen (N₂) atmosphere, although it is also possible to conduct the method under atmospheric pressure or under an increased pressure.

The method according to the present invention may comprise one or more additional steps. Any method described above may comprise such one or more additional steps. Such additional steps may comprise one or more conditioning steps, one or more polymer sorting steps, one or more comminuting steps, one or more steps to recover the at least one amine, one or more steps to recover inks and/or plastic layers, one or more solvent recovery steps, one or more rinsing or washing steps for example to remove remnants, such as amine remnants, and/or one or more drying steps.
An example of a conditioning step comprises steps to remove paper or cardboard.
Examples of comminuting steps comprise cutting, shredding, milling and/or grinding.
Polymer sorting steps comprise for example steps using wind shifting, density separation and/or near infra-red (NIR) separation.
Recovery steps of for example inks or solvents comprise for examples steps using membrane technologies, adsorption technologies and/or distillation.

As plastic material, any type of plastic material including plastic waste can be considered. The main target plastic material comprises polyolefin based material such as for example polyethylene (PE) (including low-density polyethylene (LDPE) and high-density polyethylene (HDPE)) and polypropylene (PP). However, the method according to the present invention is also suitable for other plastic materials such as polyethylene terephthalate (PET), polyurethane (PU), polyamide (PA), polystyrene (PS), polycarbonate (PC), ethylene vinyl alcohol (EVOH), ethylene vinyl acetate (EVA), polyvinyl chloride (PVC) or copolymers or combinations thereof.

Plastic material also comprises plastic waste, for example waste flows comprising polyolefin based material such as PE or PP, either rigid or non-rigid (films), such waste flows are sometimes referred to as DKR 310 (plastic films), DKR 321 (polyolefin plastic bottles), DKR 323 (mixed polyolefin items), DKR 323-2 (flexible polyolefin items), DKR 324 (polypropylene) and DKR 329 (polyethylene). The method according to the present invention is also suitable for plastic waste comprising for example PET, PU, PA, PS, PC, EVOH, EVA, PVC or copolymers or combinations thereof.

Plastic material may comprise monolayer material or multilayer material comprising multiple layers of plastic films.

Examples of monolayer material comprise polyethylene (PE) and polypropylene (PP) films.

Examples of multilayer material comprise PE/PET, PE/EVOH/PET, PE/PA, PP/PP, PP/PE/PP. Multilayer material may also comprise a metal or metallized layer such as an aluminum layer or an aluminum-based layer. An example of a multilayer comprising a metal layer is PE/AI/PET.

The plastic material such as the plastic waste may comprise contaminants and/or dirt. Contaminants refer to all the components of the plastic material that are not part of the polymer structure. Contaminants comprise for example additives, coatings, such as barrier coatings, metal coatings or biocoatings, adhesives, inks and labels such as plastic labels or paper labels. Dirt refers to impurities that adhere to the plastic material during their life cycle such as dust, soil, grease and organic waste.

Plastic waste may comprise post-industrial plastic waste and post-consumer plastic waste. Post-industrial plastic waste includes material that is used or produced in a manufacturing process and comprises for example films such as stretch films. Post-industrial plastic waste usually comprises homogeneous material, composed of a single plastic type or of a limited number of plastic types and is usually clean.

Post-consumer plastic waste includes material that has already been used by the end user and comprises for example bottles, trays, films, packaging material and household items. Post-consumer plastic waste usually comprises a mixture of different polymer materials that might be highly contaminated and dirty. The polymer material possibly suffered from degradation during service life.

Plastic material comprising or provided with ink refers to all plastic material, monolayer as well as multilayer plastic material, comprising or provided with at least one ink.

The ink can be applied on the plastic material by any technique known in the art, for example a printing technique. The at least one ink can be present on the outer surface of the plastic material or can be covered by one or more layers, for example one or more polymer layer.

The plastic material such as the plastic waste may comprise or be provided with different types of inks such as solvent-based inks, water-based inks and UV-based inks and may comprise a combination of different types of inks. The inks can be applied on top of the plastic material or between different plastic layers of a multilayer structure. Furthermore, the inks can be embedded in or covered with a layer, such as a polymer based layer, a varnish, or barrier layer. The inks can be cross-linked.

The main ingredients of inks are pigments, dyes, binders and additives, for example surfactants and/or solubilizers.

Pigments (organic or inorganic) or dyes give color and opacity to the ink and may influence the fluidity of the ink. Binders, usually low-molecular-weight polymeric resins, disperse the pigments and retain them on the plastic surface after printing. The carrier is a liquid, providing fluidity and allowing the transfer of the ink from the printing system to the substrate. Additives in the ink may for example comprise waxes, surfactants, drying agents and antioxidizing agents.

The at least one ink is for example selected from the group consisting nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, modified rosin based resins, alkyd based resins and any combination thereof.

The method according to the present invention allow to obtain simultaneous deinking and delamination, i.e. in one single step. This is an important advantage compared to methods requiring two consecutive steps. It is clear that a single step process reduces the complexity and the costs of the process considerably.

The plastic material and the at least one amine or composition as disclosed herein, may be introduced in a container to allow contacting of the plastic material with the composition. Preferably, the ratio of the volume of the plastic material (Vpm) over the volume of the composition (Vcomp) used in some embodiments, is ranging from at least 0.01 to at most 10.00, preferably from at least 0.05 to at most 7.00, preferably from at least 0.10 to at most 5.00, preferably from at least 0.50 to at most 2.50, preferably from at least 0.80 to at most 1.20.

In some embodiments, the at least one amine contacting the plastic material is present at a concentration of at least 98 wt % or in a mixture, solution, or dispersion at a concentration of at least 1 wt %.

According to a second aspect of the present invention an installation to deink plastic material, to delaminate plastic material or to deink and delaminate plastic material is provided. The installation is in particular suitable to deink plastic waste, to delaminate plastic waste and/or to deink and to delaminate plastic waste.

The installation comprises means to provide plastic material, means to provide the at least one amine and means to bring the at least one amine in contact with the plastic material. The installation may further comprise means to rinse the plastic material and/or means to dry the plastic material. Optionally, the installation to deink and/or to delaminate plastic material further comprises means to condition the plastic material, for example means to remove paper or cardboard, means for comminuting the plastic material, means to recover the amine, means to recover inks and/or plastic layers, means to recover solvent, means for rinsing or washing and/or for removing amine remnants and/or means to dry the plastic material.

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

### EXAMPLES AND EXPERIMENTAL RESULTS

### Example 1

A multilayer plastic packaging film comprising a polyethylene terephthalate (PET) layer, a nitrocellulose-based black ink, urethane-based white ink, a polyurethane-based adhesive, an aluminium layer and a PP layer, in this sequence, was reduced in size to squares with a side length of 2 cm. These squares were brought into contact with n-ethyl n-butyl amine (>98 w/w %) at 70° C. under continuous stirring with an agitator at 500 rpm. The multilayer plastic film was fully deinked and delaminated to its constituent polymer layers. The transparent delaminated plastic films (PET and PP) and the aluminium layer were separated from the medium via filtration.

### Example 2

A monolayer plastic packaging film comprising a transparent OPP substrate, a cross-linked acrylate resin, a UV-based white ink layer and a cyan ink on the top layer, was reduced in size to squares with a side length of 1 cm. These squares were brought into contact with tripropyl amine (>98 w/w %) at 80° C. under continuous stirring with an agitator at 300 rpm. The transparent OPP film was separated from the medium via filtration.

### Example 3

A multilayer plastic packaging film comprising a PET layer, a nitrocellulose-based violet ink, urethane-based white ink, a polyurethane-based adhesive and a PE layer, in this sequence, was reduced in size to squares with a side length of 4 cm. These squares were brought into contact with n-ethylcyclohexylamine (98 w/w %) at 70° C. under continuous stirring with an agitator at 300 rpm. The multilayer plastic film was fully deinked and delaminated to its constituent polymer layers. The transparent delaminated plastic films (PET and PE films) were separated from the medium via filtration.

### Example 4

A multilayer plastic packaging film comprising an oriented polypropylene (OPP) layer, a nitrocellulose-based magenta ink, a polyurethane-based adhesive and a PE layer, in this sequence, was reduced in size to squares with a side length of 2 cm. These squares were brought into contact with 1-pentyl amine (98 w/w %) at 60° C. under continuous stirring with an agitator at 400 rpm. The multilayer plastic film was fully deinked and delaminated to its constituent polymer layers. The transparent delaminated plastic films (OPP and PE films) were separated from the medium via filtration.

### Example 5

A monolayer plastic packaging film comprising an oriented polypropylene (OPP) layer, a nitrocellulose/polyurethane resin, and a solvent-based black ink layer, respectively, was reduced in size by a shredder with a sieve diameter of 0.01 cm. The obtained particles were brought into contact with dibutyl amine (>99.5 w/w %) at 80° C. under continuous stirring with an agitator at 500 rpm.

The transparent OPP film was separated from the medium via filtration.

### Example 6

A multilayer plastic packaging film comprising an oriented polypropylene (OPP) layer, a nitrocellulose-based magenta ink, a polyurethane-based adhesive and a polypropylene (PP) layer, in this sequence, was reduced in size to obtain squares with a side length of 0.5 cm. These squares were brought into contact with a composition comprising n-ethyl n-butyl amine (>98 w/w %) and cyclohexane (>99 w/w %) in a volume ratio of 75:25 v % respectively, at 65° C. under continuous stirring with an agitator at 500 rpm. The multilayer plastic film was fully deinked and delaminated to its constituent polymer layers. The transparent delaminated plastic films (OPP and PP films) were separated from the medium via filtration.

### Example 7

A multilayer plastic packaging film comprising a polyethylene terephthalate (PET) layer, a nitrocellulose-based cyan ink, urethane-based white ink, a polyurethane-based adhesive, an aluminium layer and a polypropylene (PP) layer, in this sequence, was reduced in size to obtain squares with a side length of 1 cm. These squares were brought into contact with a composition comprising n-ethyl n-propyl amine (>98 w/w %) and n-hexane (>99 w/w %) in a volume ratio of 50:50 v % respectively, at 60° C. under continuous stirring with an agitator at 500 rpm. The multilayer plastic film was fully deinked and delaminated to its constituent polymer layers. The transparent delaminated plastic films (PET and PP films) and the aluminium layer were separated from the medium via filtration.

### Example 8

A monolayer plastic packaging film comprising a transparent OPP substrate, a cross-linked acrylate resin, a UV-based white ink layer and a cyan ink on the top layer, was reduced in size to squares with a side length of 2 cm. These squares were brought into contact with a composition comprising hexylamine (99 w/w %) and water in a volume ratio of 95:5 v % respectively, at 80° C. under continuous stirring with an agitator at 400 rpm. The transparent OPP film was separated from the medium via filtration.

### Example 9

A multilayer plastic packaging film comprising an oriented polypropylene (OPP) layer, a polyurethane-based magenta ink, a polyurethane-based adhesive and a polypropylene (PP) layer, in this sequence, was reduced in size to obtain squares with a side length of 2 cm. These squares were brought into contact with a composition comprising n-ethyl n-butyl amine (>98 w/w %) and water containing KOH (1 w % in water) in a volume ratio of 75:25 v % respectively, at 65° C. under continuous stirring with an agitator at 500 rpm. The multilayer plastic film was fully deinked and delaminated to its constituent polymer layers. The transparent delaminated plastic films (OPP and PP films) were separated from the medium via filtration.

### Example 10

A monolayer plastic packaging film comprising a transparent PE substrate, a cross-linked acrylate resin, a UV-based white ink layer and a cyan ink on the top layer, was reduced in size to squares with a side length of 1 cm. These squares were brought into contact with a composition comprising n-ethyl n-butyl amine (>98 w/w %) and ethanol in a volume ratio of 75:25 v % respectively, at 60° C. under continuous stirring with an agitator at 500 rpm. The transparent PE film was separated from the medium via filtration.

1. A method to deink and/or delaminate plastic material, the method comprising the steps of:
providing plastic material, optionally comprising or provided with ink;
contacting the plastic material with at least one amine, or a composition comprising at least one amine,
wherein the at least one amine comprises a nitrogen atom substituted with one, two or three hydrocarbon substituents, with at least one of the hydrocarbon substituents comprising an acyclic alkyl group or a cyclic alkyl group, with the hydrocarbon substituents being chosen independently from each other in case the nitrogen atom is substituted with two or three hydrocarbon substituents and with the total number of carbon atoms of all hydrocarbon substituents of the nitrogen atom of the at least one amine being at least 5, and preferably at most 12.

2. The method according to claim 1, wherein the plastic material is contacted with a composition comprising the at least one amine, and wherein said composition comprises less than 0.010 weight % of a lactam, with weight % expressed based on the total weight of the composition.

3. The method according to claim 1, wherein the composition does not comprise any lactam.

4. The method according to claim 1, wherein the plastic material is contacted with a composition comprising
(A) said at least one amine; and,
(B) a liquid component, wherein said liquid component is selected from the group comprising:
(b1) water;
(b2) a hydrocarbon, preferably an alkane, preferably a C5-C12 alkane;
(b3) an alcohol;
(b4) an organic solvent which is different from the hydrocarbon in (b2) and the alcohol in (b3), and preferably selected from the group comprising acetone, acetonitrile, benzene, 2-butanone, carbon tetrachloride, chlorobenzene, chloroform, 1,2-dichloroethane, diethyl ether, diethylene glycol dimethyl ether, 1,2-dimethoxy-ethane (DME), dimethyl-formamide (DMF), dimethyl sulfoxide (DMSO), 1,4-dioxane, ethyl acetate, hexamethylphosphoramide (HMPA), hexamethylphosphorous triamide (HMPT), methyl t-butyl ether (MTBE), methylene chloride, nitromethane, petroleum ether, pyridine, tetrahydrofuran (THF), toluene, o-xylene, m-xylene, p-xylene, and any mixtures thereof;
(b5) a solution of an inorganic salt or an inorganic base, preferably an aqueous solution of an inorganic salt or an inorganic base; and,
(b6) any mixtures of (b1) to (b5).

5. The method according to claim 4, wherein the ratio of the volume of the amine(s) over the volume of the liquid component in said composition is comprised between 1/99 to 99/1, such as between 5/95 and 95/5, or between 10/90 and 90/10, or between 25/75 and 75/25, or between 40/60 and 60/40, such as about 50/50.

6. The method according to claim 1, wherein the total amount of said amine(s) in said composition is at least 98.0 weight %, or at least 98.5% weight %, or at least 99.0 weight %, or at least 99.5 weight %, or at least 99.9 weight %, with weight % based on the total weight of said composition.

7. The method according to claim 1, wherein the method further comprises the step of
separating the thus obtained plastic material from the amine or from said composition comprising said at least one amine.

8. The method according to claim 1, wherein the acyclic alkyl group of the hydrocarbon substituent can be substituted, branched or non-branched and/or wherein the cyclic alkyl group of the hydrocarbon substituent can be substituted, for example with an acyclic alkyl group, either branched or non-branched.

9. The method according to claim 1, wherein the hydrocarbon substituent or the hydrocarbon substituents is/are selected from the group consisting of methyl, ethyl, propyl, butyl, pentyl, hexyl, heptyl, octyl, cyclo-propyl, cyclo-butyl, cyclo-pentyl, cyclo-hexyl, cyclo-heptyl and cyclo-octyl, either substituted or non-substituted.

10. The method according to claim 1, wherein the at least one amine comprises a primary amine, a secondary or a tertiary amine, and preferably is a primary amine or a secondary amine, more preferably a secondary amine.

11. The method according to claim 1, wherein the at least one amine is a mono-amine.

12. The method according to claim 1, wherein every hydrocarbon substituent of the amine has at most 7 carbon atoms.

13. The method according to claim 1, wherein shear is applied to the plastic material before or while contacting the plastic material with the at least one amine or said composition comprising said at least one amine.

14. The method according to claim 1, wherein the plastic material is reduced in size to obtain plastic material having a sieve diameter ranging between 0.01 cm and 20 cm before contacting the plastic material with the amine or said composition comprising the at least one amine.

15. The method according to claim 1, wherein the plastic material is contacted with the at least one amine or said composition comprising the at least one amine, at a temperature of at least 20° C.

16. The method according to claim 1, wherein the plastic material comprises monolayer and/or multilayer plastic material.

17. The method according to claim 1, wherein the plastic material comprises or is provided with one type of ink or with a plurality of different types of inks, with the ink or inks being applied at the outer surface of a monolayer or multilayer plastic material or between different layers of a multilayer plastic material.

18. The method according to claim 1, wherein the contacting of the plastic material with the at least one amine or with said composition comprising said at least one amine is conducted under inert atmosphere.

19. The method according to claim 1, wherein said plastic material is deinked and delaminated in a single step.

20. The method according to claim 2, wherein the composition does not comprise any lactam.
